(19) United States
(12) Patent Application Publication
(10) Pub. No.: US 2026/0158384 A1
(43) Pub. Date: Jun. 11, 2026

(54) PROCESSING DEVICES AND METHODS

(71) Applicant: Sony Interactive Entertainment Inc., Tokyo (JP)

(72) Inventors: Andrew James Bigos, London (GB); Pierluigi Vito Amadori, London (GB); Pritpal Singh Panesar, London (GB); Bee Lay Tan, London (GB)

(73) Assignee: Sony Interactive Entertainment Inc., Tokyo (JP)

(21) Appl. No.: 19/392,452

(22) Filed: Nov. 18, 2025

(30) Foreign Application Priority Data
Dec. 5, 2024 (GB) 2417847.7

(51) Int. Cl. A63F 13/525; A63F 13/497

(52) U.S. Cl. CPC A63F 13/525; A63F 13/497

(57) ABSTRACT

A method of providing assistance to a given user during current gameplay of a video game, the method comprises the steps of: receiving data representative of a previous gameplay, the data representative of the previous gameplay comprising video data of the previous gameplay; generating pre-processed video data by re-projecting at least part of the video data of the previous gameplay in dependence upon at least a difference between one or more first positions within the previous gameplay and one or more corresponding second positions within the current gameplay; and overlaying the pre-processed video data over the current gameplay for display to the given user.

### FIELD OF INVENTION

The present invention relates to processing devices and methods. More specifically, the present invention relates to processing devices and methods for providing assistance to a user during current gameplay of a video game.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Modern virtual environments (e.g. those used for videogames) are often very complex and feature rich. Due to the rising complexity in virtual environments, it has become increasingly difficult to generate assistance for navigating at least some aspects of a virtual environment for a given user's needs.

It is in this context that the present disclosure arises.

### SUMMARY OF THE INVENTION

In a first aspect, a method of providing assistance to a given user during current gameplay of a video game is provided in claim 1.

In another aspect, a processing device for providing assistance to a given user during current gameplay of a video game is provided in claim 15.

Further respective aspects and features of the invention are defined in the appended claims.

### BRIEF DESCRIPTION OF THE DRAWINGS

Embodiments of the present invention will now be described by way of example with reference to the accompanying drawings, in which:

FIG. 1 schematically illustrates an example entertainment system;

FIG. 2 schematically illustrates an example method;

FIGS. 3A-3D schematically illustrate an example of image re-projection;

FIGS. 4A-4C schematically illustrate an example of image re-projection; and

FIG. 5 schematically illustrates an example processing device.

### DESCRIPTION OF THE EMBODIMENTS

In the following description, a number of specific details are presented in order to provide a thorough understanding of the embodiments of the present invention. It will be apparent, however, to a person skilled in the art that these specific details need not be employed to practice the present invention.

Conversely, specific details known to the person skilled in the art are omitted for the purposes of clarity where appropriate.

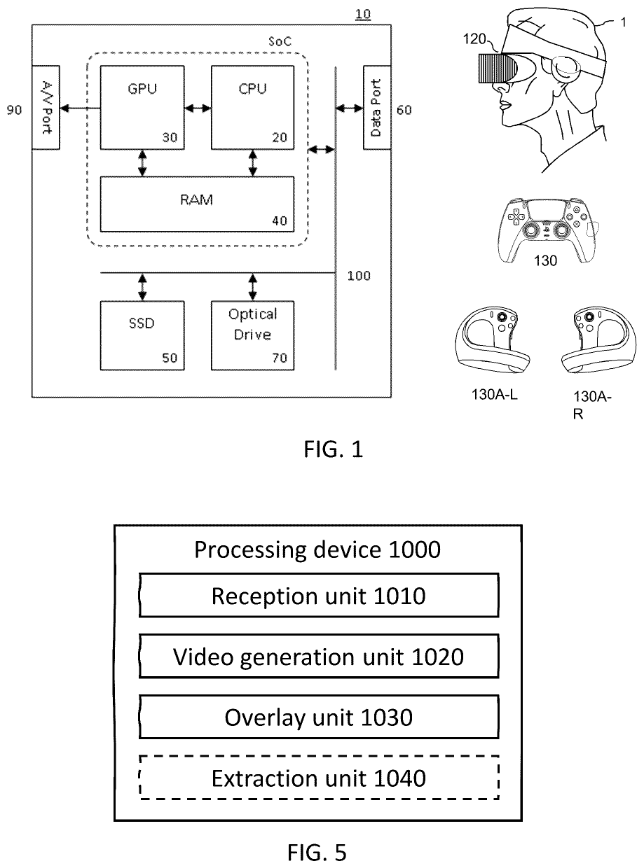

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70. Audio/visual outputs from the entertainment device are typically provided through one or more A/V ports 90 or one or more of the data ports 60. Where components are not integrated, they may be connected as appropriate either by a dedicated data link or via a bus 100.

An example of a device for displaying images output by the entertainment system is a head mounted display ‘HMD’ 120, worn by a user 1. Interaction with the system is typically provided using one or more handheld controllers 130, and/or one or more VR controllers (130A-L, R) in the case of the HMD.

Modern virtual environments (e.g. those used for videogames) are often very complex and feature rich. Due to the rising complexity in virtual environments, it has become increasingly difficult to generate assistance for navigating at least some aspects of a virtual environment for a given user's needs.

One technique for providing assistance to users has been developed specifically for racing games, where a so called ghost car may be displayed during a user's gameplay. These ghost cars are representations of a previous users' playthroughs of given races that may race alongside a user in a current playthrough. Previously, these ghost cars were directly generated using a recording of the inputs used by a respective previous user, or the state (e.g. position) of the previous user's car during gameplay, and are rendered during the rendering of the current gameplay. Therefore, these ghost cars are only available for the specific video games that support them and cannot be used for games that were not designed to incorporate this functionality.

Additionally, the ghost cars require recorded data from previous gameplay in a particular format that is specific to each implementation—without such data ghosts could not be generated. Therefore, even in a case where a given video game was subsequently updated to add ghost functionality, it is unlikely that any previous gameplay from before such an update could be used to render ghosts as it's unlikely that appropriate data for rendering ghosts would have been recorded by the video game engine prior to the update.

There is therefore a desire to provide an equivalent functionality to these ghost cars without modifying the design of the video games (and that is not limited to racing games), and that may utilise large stores of existing data of previous gameplay (such as videos of gameplay uploaded to video sharing and social media platforms).

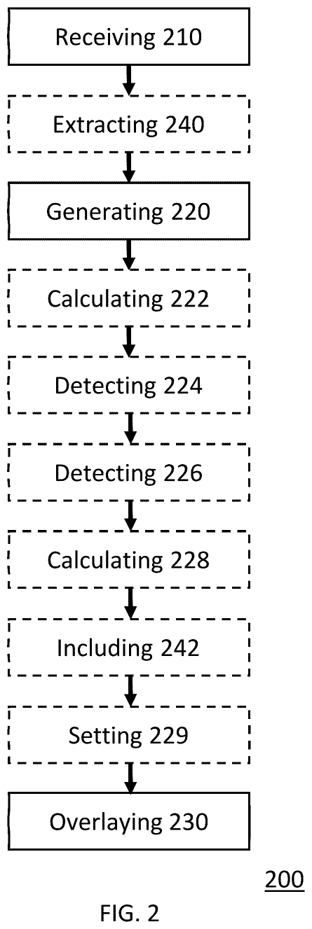

Accordingly, turning now to FIG. 2, a method of providing assistance to a given user during current gameplay of a video game is provided in accordance with embodiments of the present disclosure.

The method 200 comprises a step of receiving 210 data representative of a previous gameplay. The data representative of the previous gameplay comprises video data of the previous gameplay.

The method 200 further comprises a step of generating 220 pre-processed video data by re-projecting at least part of the video data of the previous gameplay in dependence upon at least a difference between one or more first positions within the previous gameplay and one or more corresponding second positions within the current gameplay.

The method 200 also comprises a step of overlaying 230 the pre-processed video data over the current gameplay for display to the given user.

The data representative of a previous gameplay may be representative of previous gameplay of the given user. Alternatively, the data may be representative of previous gameplay of another user, such as a user having a skill level above a predetermined threshold, a user that is selected by the given user, or a user that is associated with the given user (e.g. the two users are friends on a social network) for example.

The previous gameplay is a gameplay corresponding to the current gameplay. For example, the previous gameplay may occur in the same (or a similar) region of a virtual environment as the current gameplay. Alternatively, or in addition, the previous gameplay may be gameplay of a particular level/mission/task/quest/etc. that corresponds to the level/mission/task/quest/etc. of the current gameplay.

As noted above, the data representative of the previous gameplay comprises video data of the previous gameplay, for example in the form of a video recording. However, it will be appreciated that the data representative of the previous gameplay may optionally comprise metadata associated with the previous gameplay. For example, the metadata may be indicative of the video game in the previous gameplay, an identity of a user that is performing the previous gameplay, a date and/or time when the previous gameplay was performed, a length of the previous gameplay (i.e. a temporal length), or any other suitable metadata that may be associated with the previous gameplay. Optionally it may include data indicating the in-game position and orientation of the virtual camera used to generate the images in the video.

The video data of the previous gameplay may be video data that is recorded specifically for the performing the method 200. However, it will be appreciated that method 200 may advantageously use video data of previous gameplay that has been recorded for other purposes (such as video of previous gameplay recorded for a so called “let's play” documenting a playthrough of a video game, or a livestream of a video game playthrough).

Additionally, it will be appreciated that the video data of the previous gameplay is not limited to video data comprising complete rendered frames of the previous gameplay. For example, rendered frames of the previous gameplay may be cropped (e.g. by removing portions of respective frames that comprise user interface, UI, elements).

Alternatively, or in addition, a rendered frame of the previous gameplay may be provided at a reduced resolution for receipt in the step 210. For example, if a frame was originally rendered at a resolution of 1920×1080, the frame's resolution may be reduced to, for example, 1280×720 or any other reduced resolution. Additionally, the aspect ratio of the reduced resolution frame may be different to that of the originally rendered frame (e.g. if a reduced resolution of 960×720 is used). In such cases, the reduced aspect ratio may be achieved either by using a different sampling density in the vertical and horizontal directions, or by cropping the rendered frames of previous gameplay, as discussed above.

It will also be appreciated that the video data of the previous gameplay is not limited to video data comprising a continuous sequence of rendered frames. For example, only a continuous sequence of rendered frames may be sampled prior to being received at step 210. As an illustrative example, only 1 out of every 10, 20, 30, 40 or any other number of frames may be included in the video data to be received. As another example, only I-frames may be received (i.e. no P-frames or B-frames are included in the video data to be received).

As noted above, at least part of the received video data of the previous gameplay is re-projected in dependence upon at least a difference between one or more first positions within the previous gameplay and one or more corresponding second positions within the current gameplay.

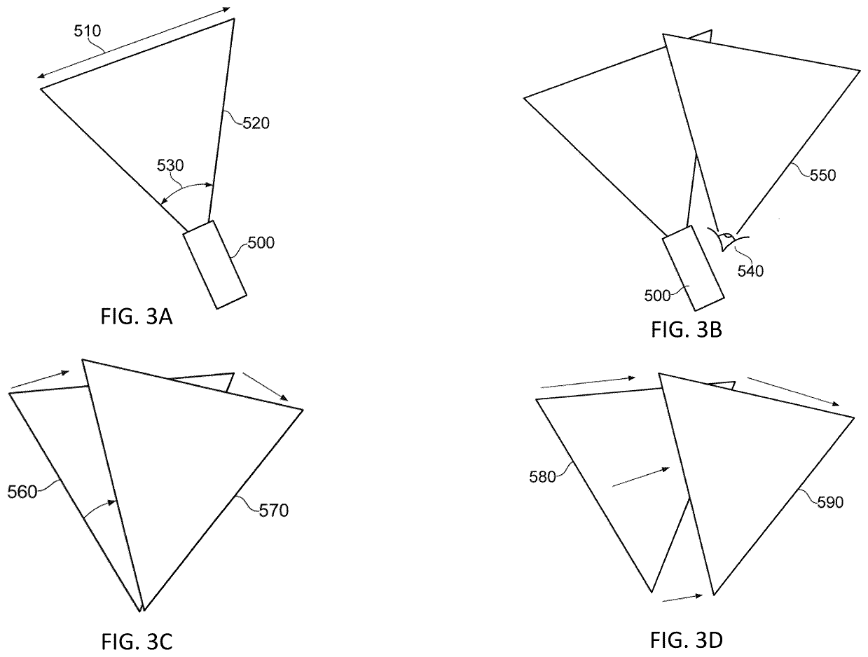

The general concept of image re-projection will now be discussed with reference to FIGS. 3A-3D.

A virtual camera, such as the virtual camera 500, has an associated viewing frustum (a general term indicative of the field of view of the virtual camera, ranging between a wide-angle field of view and a narrow angle or telephoto field of view, and which may be expressed as an angular range corresponding to, for example, the angle 530 shown in FIG. 3A).

FIG. 3B schematically illustrates the re-projection of an image captured by the schematic virtual camera of FIG. 3A according to a virtual viewpoint. The virtual viewpoint 540 is schematically illustrated by an eye symbol and a generally triangular shape 550 which is similar to the triangular shape 520. In order to display the image captured by the virtual camera 500 so that it is appropriate for viewing according to the virtual viewpoint shown in FIG. 3B, a process is carried out which relates the position and/or orientation of the virtual viewpoint to the position and/or orientation of the virtual camera 500. Examples of such techniques will be described with reference to FIGS. 3C and 3D.

FIG. 3C schematically illustrates an image rotation from a first viewpoint 560 to a second viewpoint 570. Re-projection of this type involves simply rotating and scaling the image so as to correct for any differences in field of view and orientation between the viewpoint of the virtual camera and the virtual viewpoint.

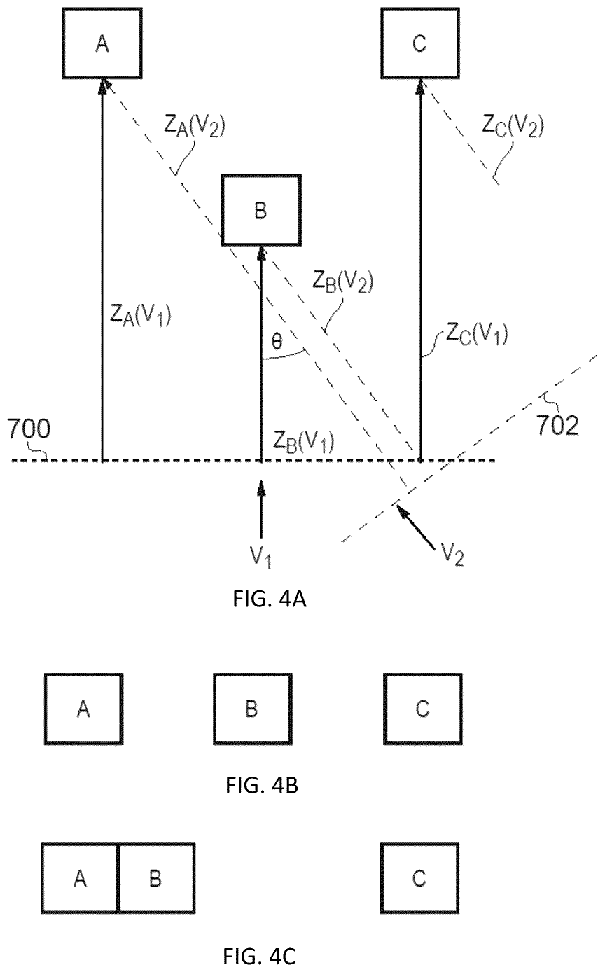

FIG. 3D schematically illustrates an image rotation and translation from a first viewpoint 580 to a second viewpoint 590. Here, the processing is slightly more involved, and may also use depth buffer data or a depth map, indicating the image depth of different image features in the captured image, to allow the viewpoint of the camera to be translated with respect to the virtual viewpoint. Examples of the use of a depth map will be discussed below with reference to FIGS. 4A-4C.

Note that the above discussion of re-projection has just been provided to illustrate general aspects of the techniques. These techniques are all applicable to machine-generated images such as images generated by a computer games machine for display to a user as part of the process of playing a computer game. In such an environment, a virtual camera representing an in-game viewpoint may be implemented.

Referring again to the step of generating 220, optionally, in some embodiments of the present disclosure, one of the first positons may be a position of a virtual camera within the previous gameplay. In these embodiments, a corresponding one of the second positions may be a position of a corresponding virtual camera within the current gameplay.

With reference to the above discussion of re-projection, in these embodiments, the first viewpoint 560, 580 may be based on the position of the virtual camera within the previous gameplay, and the second viewpoint 570, 590 may be based on the position of the corresponding virtual camera within the current gameplay.

It will be appreciated that one or both of the current gameplay and previous gameplay may optionally comprise more than one virtual cameras and/or viewpoints. For example, one of the current/previous gameplay may be split screen gameplay.

For example, in the case where the previous gameplay comprises more than one virtual cameras and/or viewpoints, only video data of one of these viewpoints may be re-projected. In the case where the current gameplay comprises more than one virtual camera and/or viewpoint, at least part of the video data of the previous gameplay may be re-projected for each of the virtual cameras and/or viewpoints in the current gameplay.

In the case where both of the current gameplay and previous gameplay comprise more than one virtual camera and/or viewpoint, at least part of the video data from respective virtual cameras and/or viewpoints of the previous gameplay may be re-projected to respective virtual cameras and/or viewpoints of the current gameplay. Although in this case, video data from the same virtual camera and/or viewpoint of the previous gameplay may be re-projected to for multiple respective virtual cameras and/or viewpoints of the current gameplay (such as when the particular virtual camera and/or viewpoint in the previous gameplay is spatially closer to the multiple respective virtual cameras and/or viewpoints of the current gameplay in comparison to the other virtual cameras and/or viewpoints of the previous gameplay).

In order to re-project images by taking into account translations of the viewpoint, embodiments of the disclosure may optionally use virtual camera information (position and orientation) included as metadata in the recorded video, if available (for example if the video was recoded in support of the techniques herein) and compare this with the corresponding virtual camera information for the current game. However, for many cases such metadata will not be available.

Alternatively or in addition, in order to re-project images by taking into account translations of the viewpoint, embodiments of the disclosure may use depth information associated with the images. For example, depth buffer data or a depth map may be generated as part of the operation of a computer games machine's rendering engine when rendering image frames for gameplay.

In the schematic example of FIG. 4A, three image objects are labelled as objects A, B and C. Two potential viewpoints are shown, labelled as a viewpoint v₁ and a viewpoint v₂ respectively.

The objects are shown with respect to a viewpoint v₁, are at respective image depths measured from an arbitrary depth position 700 of z_{A}(v₁), z_{B}(v₁) and z_{C}(v₁).

If the viewpoint is changed to a viewpoint v₂ at an angle θ to that of the viewpoint v₁, then the arbitrary depth position 700 rotates by θ to a revised position 702 and the respective image depths measured from the arbitrary depth position 702 are z_{A}(v₁), z_{B}(v₁) and z_{C}(v₁), where for each object in this example, z(v₂)=z(v₁).cos(θ).

FIGS. 4B and 4C schematically illustrate portions of images according to the viewpoint v₁ and the viewpoint v₂ respectively. At a rendering stage, the depth of each of the image objects is taken into account in generating the images. However, this technique can also be used at a re-projection stage, so that image objects may be moved relative to one another in the re-projected image according to their respective image depths. Accordingly, embodiments of the disclosure may involve providing depth data indicating the image depth of one or more image features, and the re-projecting can comprise repositioning one or more image features within the re-projected image according to the depth data.

Therefore, in embodiments of the present disclosure, the data representative of the previous gameplay may optionally comprise depth buffer data of the video data of the previous gameplay. In these embodiments, the step of generating 220 the pre-processed video data may optionally comprise (as indicated by the dashed outline in FIG. 2) a step of calculating 222 a difference between at least one of the first positions and at least one of the corresponding second positions in dependence upon the depth buffer data, as described in more detail above with reference to FIGS. 4A-4C.

Alternatively, or in addition, in embodiments of the present disclosure, the step of generating 220 the pre-processed video data may further comprise a step of detecting 224, as at least one of the first positions, a position of one or more image features (such as the objects A, B and C in FIG. 4B) in the video data of the previous gameplay. In these embodiments, the step of generating 220 may further comprise a step of detecting 226, as at least one of the corresponding second positions, a position of at least one of the one or more image features (such as the objects A, B and C in FIG. 4C) within the current gameplay. In these embodiments, the step of generating may further comprise a step of calculating 228 a difference between the at least one detected first positon and the at least one detected corresponding second position.

In some cases, the one or more image features may correspond to one or more virtual assets that are respectively positioned at fixed points in a virtual environment used for the previous gameplay and the current gameplay. Optionally, the one or more image features may correspond to one or more predetermined virtual assets, which may, for example, be preselected by a developer, or virtual assets whose properties characterise them as being fixed relative to the virtual environment.

It will be appreciated that a position of a viewpoint may be estimated based on the appearance of a known virtual asset at a known position in images captured from the viewpoint. Such information may be known in advance based on information representative of the layout of the virtual environment used for the previous gameplay and the current gameplay. The problem of estimating a viewpoint's position based on the appearance of known 3D points in images captured at the viewpoint are known as Perspective-n-Point (PnP) problems. It will be appreciated that any suitable techniques for solving PnP problems may be used in these embodiments of the present disclosure.

Hence, with two out of three pieces of information, the third can be derived: for the currently played game, the position of virtual assets in the currently played game, the virtual camera position and orientation, and the displayed position of the virtual assets are all known; consequently, for a recording of an earlier instance of the game, for the same position of virtual assets in the game, and given the displayed position of these assets in the video image, it is possible to calculate the virtual camera position and orientation for the recorded video that accounts for this displayed position. This in turn then provides the difference in the current and recorded viewpoints, which can be used to re-project some or all of the image. Consequently in this case the recorded video can be legacy video that does not include any metadata, depth data, or other data specifically provided to facilitate the techniques herein.

In some cases, the one or more predetermined virtual assets may not need to be positioned at a fixed point in the virtual environment. For example, the predetermined virtual asset may be a predetermined non-player character (NPC) (such as a boss NPC), a vehicle, a moving platform, a virtual object (such as a virtual ball), etc.

In these cases, the predetermined virtual asset may be used as a reference frame, so that a translation of viewpoints between the current gameplay and previous gameplay is measured with respect to the predetermined virtual asset when performing the re-projection (instead of the virtual environment being used as the reference frame).

It will be appreciated that, in some embodiments of the present disclosure, the pre-processed video data generated in the generating step 220 may be representative of at least some of the re-projected part of the video data of the previous gameplay. In some cases, the pre-processed video data may not comprise any of the video data of the previous gameplay. In these cases, the re-projected video data of the previous gameplay may simply be used for positioning one or more assets in the pre-processed video data.

As an example, the video data of the previous gameplay may comprise video data of an avatar controlled by the user of the previous gameplay. The video data of the previous gameplay may be re-projected in accordance with the techniques discussed elsewhere herein in order for the previous user's avatar's position in the previous gameplay to be determined relative to the current gameplay. The pre-processed video may then be generated by generating a video comprising a virtual asset at the position corresponding to the position of the avatar of the previous user in the re-projected video data of the previous gameplay.

It will be appreciated that the virtual asset may correspond to (i.e. be a likeness of the previous user's avatar). Alternatively, the virtual asset may be a marker, such as a basic shape that is indicative of the previous avatar's position but may not provide any further information to the user of the current gameplay. Although in some cases, even a relatively simple marker may be used to provide additional assistance to the user. For example, the colour of the marker may be dependent upon actions taken by the previous user. As an illustrative example, the marker may flash one colour (e.g. red) in response to the previous user performing an attack action, and may flash another colour (e.g. green) in response to the previous user perform an dodge action.

Alternatively, or in addition, in some embodiments of the present disclosure, the method 200 may optionally comprise a step of extracting 240 one or more image features from the video data of the previous gameplay. In these embodiments, the step of generating 220 the pre-processed video data may further comprise a step of including 240 the extracted image features in the pre-processed video data.

Optionally, in these embodiments, one or more of the image features may correspond to an avatar of a user of the previous gameplay in the video data of the previous gameplay. Alternatively, or in addition, one or more of the image features may correspond to one or more predetermined virtual assets, such as one or more of the predetermined virtual assets discussed elsewhere herein.

Optionally, the one or more predetermined assets may be assets selected by the user playing the current gameplay as assets to be overlaid on video data of the current gameplay.

In these embodiments, the pre-processed video data may optionally consist of the extracted image features after they have been re-projected. It will be appreciated that, whilst the pre-processed video data is generated by re-projecting the video data of the previous gameplay, not all of the video data of the previous gameplay has to be included in the pre-processed video data. In fact, in some cases, only some, but not all, of the video data of the previous gameplay will be comprised by the pre-processed video data, and in other cases none of the video data of the previous gameplay will be comprised by the pre-processed video data as discussed above (although in some cases all of the video data of the previous gameplay may be comprised by the pre-processed video data).

For example, image features that represent virtual assets positioned at fixed points in a virtual environment, or image features that represent the virtual environment itself, may not be included in the pre-processed video data. However, these image features may still be used in the process of re-projecting the video data of the previous gameplay even if these image features are not comprised by the pre-processed video data due to not being extracted in step 240.

The steps of extracting 240 and including 242 may advantageously prevent perceptible visual errors caused by re-projection errors by limiting which image features from the video data of the previous gameplay are included in the pre-processed video data.

As an example, for image features that correspond to the virtual environment or at least virtual assets that have a fixed position (or path) relative to the virtual environment (hereinafter such image features will be referred to as static image features), if there is any error in their re-projection, such an error will be visually perceptible if these re-projected static image features are overlaid over the current gameplay. This is because these static image features will be overlaid over their counterparts in the current gameplay. Therefore, any mismatch between their re-projected position and the position of their counterpart in the current gameplay, no matter how small, will be noticeable since they are expected to match.

Contrastingly, for dynamic image features that correspond to elements that are dynamic (i.e. may move relative to a default position (or path) in the virtual environment), these image features may not have a counterpart at the same position relative to the virtual environment in the current gameplay.

Therefore, when these dynamic image features are overlaid over the current gameplay, they may not have a counterpart at the same position relative to the virtual environment. Therefore, even if there is an error between their re-projected position compared to their position in the previous gameplay, this will not be visually perceptible since there is no point of reference in the current gameplay.

The term “element” is used herein to refer to any feature of the gameplay. For example, a virtual asset, a portion of a virtual environment, an avatar, a virtual projectile (such as a spell or an arrow), user interface (UI) elements, etc.

It will be appreciated that some elements that are initially static may become dynamic. For example, a virtual asset may be considered a static virtual asset when it is in its default position (or path) in the virtual environment even though the virtual asset may not be fixed in place. In response to the the virtual asset being moved from its default positon (or path) in the virtual environment, the virtual asset may be considered a dynamic virtual asset (even if the virtual asset is stationary with respect to the virtual environment).

Additionally, some elements may move with respect to the virtual environment but still be static elements. For example, a virtual asset (such as an NPC or a train) may follow a predetermined path in the virtual environment. As long as the virtual asset does not deviate from the predetermined path, it may be considered a static element. In response to the asset deviating from the predetermined path (e.g. due to the user interacting with the NPC or operating the controls of the train) the element may be considered dynamic.

In a more general sense, elements may be considered static when they share the same position with respect to the virtual environment in both the current gameplay and the previous gameplay.

Meanwhile, an element may be considered dynamic if there is a difference between its position in the current gameplay and the previous gameplay with respect to the virtual environment. Therefore, even if an element is in its default position (or path) in one of the current gameplay and previous gameplay, it may be considered a dynamic element in response to being moved from its default positon (or path) in the other one of the current gameplay and previous gameplay. In some cases, UI elements may be an exception to this definition. In particular, UI elements may, in some cases, always be considered as static elements. Alternatively, UI elements may be categorised separately to both the static elements and the dynamic elements.

Additionally, elements in one of the current gameplay and previous gameplay that do not have any counterpart in the other of the current gameplay and previous gameplay may be considered dynamic elements. For example, a user in one of the current gameplay and previous gameplay may cast a spell to summon an NPC (such as a spooky skeleton) for assistance in combat whilst a user in the other one of the current gameplay and previous gameplay does not. In this case, the summoned NPC may be considered a dynamic element.

Optionally, in some embodiments of the present disclosure, the image features extracted in step 240 may correspond to dynamic elements. In these embodiments, the pre-processed video data may not comprise any image features that correspond to static elements (e.g. the pre-processed video data may consist of image features that correspond to dynamic elements).

As noted above, the pre-processed video data is overlaid over the current gameplay for display to the given user at step 230. By overlaying 230 the pre-processed video data of the previous gameplay over the current gameplay for display, assistance may be provided to the given user for the current gameplay in the form of the previous gameplay in the same area of visual attention as the current gameplay. Additionally, due the re-projection of the video data of the previous gameplay, a distortion of perspective of the overlaid video data may be minimised.

In some embodiments, the step of overlaying 230 the pre-processed video data over the current gameplay for display to the given user may comprise overlaying the pre-processed video data over rendered image frames of the current gameplay for display to the given user.

It will be appreciated that the method 200 may produce results similar to so called ghost cars that may be used in racing video games. These ghost cars are representations of a previous users' playthroughs of given races that may race alongside a user in a current playthrough. However, unlike the techniques of the present disclosure, these ghost cars are directly generated using a recording of the inputs used by a respective previous user, and are rendered during the rendering of the current gameplay. Therefore, these ghost cars are only available for the specific video games that support them and cannot be used for games that were not designed to incorporate this functionality.

Additionally, the ghost cars require recorded data from previous gameplay in a particular format that is specific to each implementation—without such data ghosts could not be generated. Therefore, even in a case where a given video game was subsequently updated to add ghost functionality, it is unlikely that any previous gameplay from before such an update could be used to render ghosts as it's unlikely that appropriate data for rendering ghosts would have been recorded by the video game engine prior to the update.

In contrast to these ghost cars, the techniques of the present disclosure may be used with video games that were not designed to implement such functionality without modifying the design of the video games, and may also generate pre-processed data of a previous playthrough to overlay over current gameplay based on only video data of a previous playthrough. Therefore, the present techniques may utilise large stores of existing video data of previous gameplay (such as videos of gameplay uploaded to video sharing and social media platforms). It will also be appreciated that the present techniques are not limited to racing games but may be used for any other genre or style of video game.

In some embodiments of the present disclose, at least one frame of the pre-processed video data may comprise data representative of a plurality of frames of the video data of the previous gameplay. In these cases, the overlay may illustrate a timeline of the previous gameplay.

For example, in the case where the pre-processed video data includes an avatar of the user of the previous gameplay, the pre-processed video data may include video data of the avatar in the previous gameplay at different points of time. This may enable the overlay to illustrate the avatar's actions as a ghost trail for example. In some cases, the actions of the avatar may be replayed in real time in the pre-processed video data, but the pre-processed video data may also simultaneously display the avatar's past and/or future actions (relative to their actions in the real time replay).

In some cases, the real time replay may be played at the original frame rate of the video data of the previous gameplay, and at least some of a subset of those frames may be used for the ghost trail. The subset of frames used for the ghost trail may comprise the frames at predetermined separation with respect to a given reference frame. The separation (sometimes referred to as the frame interval) may, for example, be every 30 frames, 60 frames, 120 frames, 10 frames, 64 frames, or any other number of frames), or any other suitable frame interval may be used. Only using a subset of frames for the ghost trail may prevent the ghost trail from blurring.

Only some of the frames in the subset may be used for the ghost trail. For example, only the N frames in the subset that immediately precede the current frame of the real time replay, and/or the M frames in the subset that immediately follow the current frame of the real time replay, may be used for the ghost trail. In some cases, the distribution of frames from the subset that are used for the ghost trail may not be uniform. For example, all of the first five frames in the subset that immediately precede/follow the current frame may be used for the trail. Meanwhile, only every other frame in the next ten preceding/following frames may be used, and one in every three frames in the next 15 preceding/following frames may used, etc. Accordingly, the ghost trail will be denser when near to the current frame of the replay, and sparser when far from the current frame of the replay.

In some cases, the given reference frame may be an initial frame (or any other fixed frame). In these cases, the ghost trail will not be animated as the frames that make up the subset will not change as the real time replay progresses (although the frames in the subset that are used may change as noted above). In this case, the ghost will appear to leave behind and/or move through a series of static images of itself, where the separation between the images is set by the frame interval discussed above. Alternatively, the given reference frame may be the current frame of the real time replay. In this case, the subset will be updated when the current frame of the real time replay changes.

Therefore, the ghost trail will comprise a series of real time replays.

It will be appreciated that the above described ghost trail does is not limited to a case where the pre-processed video data comprises at least some of the video data of the previous gameplay. For example, in some cases the ghost trail may be generated by generating a video comprising virtual assets at respective positions corresponding to the positions of the avatar of the previous user at the different points of time in the re-projected video data of the previous gameplay. It will be appreciated that, optionally, only the positions of the previous user's avatar from a subset of the frames of the video data of the previous gameplay may be used as discussed above.

Such a ghost trail may appear as a trail of breadcrumbs that indicates the position of the previous user's avatar over time. As discussed elsewhere herein, a colour of respective virtual assets used to generate the ghost trail may be dependent upon an action being taken by the previous user's avatar at respective points in time.

In some cases, the rather than using discrete virtual assets, the positions of the avatar of the previous user at the different points of time in the re-projected video data of the previous gameplay may be interpolated so that a continuous virtual asset (such as a line) passing through each of the positions for the pre-processed video data.

In some embodiments of the present disclosure, the step of generating 220 the pre-processed video data comprises a step of setting 229 an alpha value of one or more image regions of the video data of the previous gameplay.

As an example, an alpha value (where an alpha value of 0 indicates full transparency and an alpha value of 1 indicates full opacity) may be set for the entire pre-processed video so that a translucent representation of the pre-processed video overlays the video data of the current gameplay. The particular value for the alpha value may be set by a user for example (such as by using a configurable slider).

Alternatively, in some cases, different regions of the pre-processed video may have different alpha values set in comparison to each other. The regions of the pre-processed video may correspond to at least one of the image features, predetermined virtual assets, static elements, dynamic elements, UI elements, and/or an avatar of a user (each of which have been described in more detail elsewhere herein). It will be appreciated that the regions may be based on the previous gameplay and/or the current gameplay.

In cases where at least some of the regions are based on the previous gameplay, regions corresponding to more significant elements of the previous gameplay (such as the previous user's avatar) may have an alpha value set to be higher (i.e. more opaque) than regions corresponding to one or more less significant elements, which may have a lower alpha value set (i.e. more transparent).

Therefore, the regions corresponding to more significant elements of the previous gameplay may be more visible in the overlay than the other regions, which may prevent the overlay from occluding too much of the current gameplay whilst still providing a user with relevant assistance.

Alternatively, or in addition, in cases where at least some of the regions are based on the current gameplay, regions corresponding to more significant elements of the current gameplay (such as the current user's avatar) may have an alpha value set to be lower (i.e. more transparent) than regions corresponding to one or more less significant elements, which may have a higher alpha value set (i.e. more opaque). Therefore, the regions of the overlay that correspond to more significant elements in the current gameplay may be less visible, which may prevent the overlay from occluding the regions of interest in the current gameplay whilst still providing a user with relevant assistance.

The significance of particular elements may be set by a user or developer. For example, the region corresponding to the avatar of the user may be set as the most significant element (and therefore have the highest opacity if it is the avatar of the previous gameplay, or the highest transparency if it is the avatar of the current gameplay).

Optionally, the step of setting the alpha value may be dependent upon one or more properties of the video game. For example, the significance of various elements in the video game may be determined based on one or more properties of the video game. As an example, elements that possess a greater level of interactivity may be given a higher significance. Meanwhile, static elements (as described elsewhere herein) may be given a lower significance. The alpha values for image regions corresponding to these elements may then be set in dependence upon these properties (and whether the elements are in the current gameplay and/or the previous gameplay) as described above.

Optionally, static elements may have an alpha value close to or at zero, so that they do not affect the fidelity of corresponding elements in the current image; meanwhile dynamic elements in the video may have an alpha value set as a function of their distance from the corresponding dynamic element in the current game play (after re-projection), so that when they substantially overlap they are (or are almost) transparent, and become more opaque as the distance from the their counterpart in the current gameplay increases (e.g. up to a maximum opacity, to make clear they are still ghosts). This allows the user to track the ghost(s) without them significantly affecting the fidelity of the player avatar, enemies, or the like within the current game.

Optionally, dynamic elements in the video for which corresponding dynamic elements are not detected in the current game play may be made wholly transparent to avoid confusion. Similarly optionally, as discussed elsewhere herein only the avatar (e.g. user-controlled element of the game) in the video has an alpha value other than zero or close to zero.

As another example, a level of significance for various NPCs may be calculated in dependence on an amount of health points (HP) a respective NPC has. In this example, an NPC with a higher amount of HP may be given a higher level of significance (e.g. since it corresponds to a boss NPC). One or more other NPC properties may alternatively or additionally be used. Additionally, any other suitable video game properties may be used with the present techniques, as will be apparent to the skilled person.

Turning now to FIG. 5, in embodiments of the present disclosure, processing device 1000 for providing assistance to a given user during current gameplay of a video game is provided. the processing device comprises: a reception unit 1010, a video generation unit 1020, an overlay unit 1030, and optionally (as indicated by the dashed outline in FIG. 5) an extraction unit 1040.

The reception unit 1010 is configured to receive data representative of a previous gameplay. The data representative of the previous gameplay comprising video data of the previous gameplay.

The video generation unit 1020 is configured to generate pre-processed video data by re-projecting at least part of the video data of the previous gameplay in dependence upon at least a difference between one or more first positions within the previous gameplay and one or more corresponding second positions within the current gameplay.

The overlay unit 1030 is configured to overlay the pre-processed video data over the current gameplay for display to the given user.

The optional extraction unit 1040 may be configured to extract one or more image features from the video data of the previous gameplay. In these cases, the video generation unit is configured to including the extracted image features in the pre-processed video data.

Modifications to the processing device 500 corresponding to the modifications described elsewhere herein will be apparent to the skilled person.

It will be appreciated that the above methods may be carried out on conventional hardware suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, in a summary embodiment of the present description, the processing device 1000 may be implemented on, for example, a server (not shown) or entertainment device 10.

Instances of this summary embodiments implementing the methods and techniques described herein (for example by use of suitable software instruction) are envisaged within the scope of the application. The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method of providing assistance to a given user during current gameplay of a video game, comprising:
receiving data representative of a previous gameplay, the data representative of the previous gameplay comprising video data of the previous gameplay;
generating pre-processed video data by re-projecting at least part of the video data of the previous gameplay in dependence upon at least a difference between one or more first positions within the previous gameplay and one or more corresponding second positions within the current gameplay; and
overlaying the pre-processed video data over the current gameplay for display to the given user.

2. The method of claim 1, wherein
one of the one or more first positons is a position of a virtual camera within the previous gameplay, and a corresponding one of the one or more second positions is a position of a corresponding virtual camera within the current gameplay.

3. The method of claim 1, wherein
the data representative of the previous gameplay comprises depth buffer data of the video data of the previous gameplay, and
the generating the pre-processed video data further comprises calculating a difference between at least one of the one or more first positions and at least one of the one or more corresponding second positions in dependence upon the depth buffer data.

4. The method of claim 1, wherein the generating the pre-processed video data further comprises:
detecting, as at least one of the one or more first positions, a position of one or more image features in the video data of the previous gameplay;
detecting, as at least one of the one or more corresponding second positions, a position of at least one of the one or more image features within the current gameplay; and
calculating a difference between the at least one detected first positon and the at least one detected corresponding second position.

5. The method of claim 4, wherein
the one or more image features correspond to one or more virtual assets that are respectively positioned at fixed points in a virtual environment used for the previous gameplay and the current gameplay.

6. The method of claim 1,
further comprising extracting one or more image features from the video data of the previous gameplay
wherein the generating the pre-processed video data further comprises including the extracted image features in the pre-processed video data.

7. The method of claim 6, wherein
one or more of the image features correspond to an avatar of a user of the previous gameplay in the video data of the previous gameplay.

8. The method of claim 4, wherein
one or more of the image features correspond to one or more predetermined virtual assets.

9. The method of claim 1, wherein
at least one frame of the pre-processed video data comprises data representative of a plurality of frames of the video data of the previous gameplay.

10. The method of claim 1, wherein the
overlaying the pre-processed video data over the current gameplay for display to the given user comprises overlaying the pre-processed video data over rendered image frames of the current gameplay for display to the given user.

11. The method of claim 1, wherein the
generating the pre-processed video data comprises a step of setting an alpha value of one or more image regions of the video data of the previous gameplay.

12. The method of claim 11, wherein the
setting the alpha value is dependent upon one or more properties of the video game.

13. (canceled)

14. (canceled)

15. A processing device for providing assistance to a given user during current gameplay of a video game, comprising a circuitry configured to:
receive data representative of a previous gameplay, the data representative of the previous gameplay comprising video data of the previous gameplay;
generate pre-processed video data by re-projecting at least part of the video data of the previous gameplay in dependence upon at least a difference between one or more first positions within the previous gameplay and one or more corresponding second positions within the current gameplay; and
overlay the pre-processed video data over the current gameplay for display to the given user.

16. The processing device of claim 15, wherein the data representative of the previous gameplay comprises depth buffer data of the video data of the previous gameplay, and
the generating the pre-processed video data further comprises calculating a difference between at least one of the one or more first positions and at least one of the one or more corresponding second positions in dependence upon the depth buffer data.

17. The processing device of claim 15, wherein the generating the pre-processed video data further comprises:
detecting, as at least one of the one or more first positions, a position of one or more image features in the video data of the previous gameplay;
detecting, as at least one of the one or more corresponding second positions, a position of at least one of the one or more image features within the current gameplay; and
calculating a difference between the at least one detected first positon and the at least one detected corresponding second position.

18. The processing device of claim 17, wherein the one or more image features correspond to one or more virtual assets that are respectively positioned at fixed points in a virtual environment used for the previous gameplay and the current gameplay.

19. A system comprising:
one or more processors; and
one or more computer-readable media storing instructions which, when executed by the one or more processors, cause the system to perform operations comprising:
receiving data representative of a previous gameplay, the data representative of the previous gameplay comprising video data of the previous gameplay;
generating pre-processed video data by re-projecting at least part of the video data of the previous gameplay in dependence upon at least a difference between one or more first positions within the previous gameplay and one or more corresponding second positions within a current gameplay of a video game; and
overlaying the pre-processed video data over the current gameplay for display to a given user.

20. The system of claim 19, wherein the data representative of the previous gameplay comprises depth buffer data of the video data of the previous gameplay, and
the generating the pre-processed video data further comprises calculating a difference between at least one of the one or more first positions and at least one of the one or more corresponding second positions in dependence upon the depth buffer data.

21. The system of claim 19, wherein the generating the pre-processed video data further comprises:
detecting, as at least one of the one or more first positions, a position of one or more image features in the video data of the previous gameplay;
detecting, as at least one of the one or more corresponding second positions, a position of at least one of the one or more image features within the current gameplay; and
calculating a difference between the at least one detected first positon and the at least one detected corresponding second position.

22. The system of claim 21, wherein the one or more image features correspond to one or more virtual assets that are respectively positioned at fixed points in a virtual environment used for the previous gameplay and the current gameplay.
